(19) United States
(12) Patent Application Publication
(10) Pub. No.: US 2009/0174712 A1
(43) Pub. Date: Jul. 9, 2009

(54) METHOD, APPARATUS AND COMPUTER-READABLE MEDIUM FOR SCALE-BASED VISUALIZATION OF AN IMAGE DATASET

(75) Inventor: Hubrecht Lambertus Tjalling De Bliek, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: SANDVIKEN INTELLECTUAL PROPERTY AB, SANDVIKEN (SE)

(21) Appl. No.: 12/375,576

(22) PCT Filed: Jul. 5, 2007
(86) PCT No.: PCT/IB07/52638

§ 371 Date: Jan. 29, 2009

(30) Foreign Application Priority Data
Jul. 31, 2006 (EP) 06118153.3

(51) Int. Cl. G06T 17/00; G06K 9/00

(52) U.S. Cl. 345/424; 382/128; 382/131

(57) ABSTRACT

A method for use in scale-based visualization of an image dataset is provided. The method comprises identifying a first set of voxels of the image dataset, wherein the voxels of the first set of voxels comprises gray values that are statistically frequently present in the image dataset, identifying a second set of voxels, wherein the voxels of the second set of voxels comprises gray values that are not statistically frequently present in the image dataset, and calculating a scale based on the first set of voxels and the second set of voxels using a transfer function, wherein the transfer function is non-linear. The method offers high manipulation accuracy where required within a limited amount of display space, by changing the linear interaction scale into a non-linear scale. Important image/volume gray values are given a higher percentage of interaction space on the available display space than other less important gray values.

### FIELD OF THE INVENTION

This invention pertains in general to the field of image analysis. More particularly the invention relates 3-D volume visualization for displaying structures present in a scanned volume, e.g. from Computed Tomography (CT), Magnetic Resonance Imaging (MRI), or Ultrasound Imaging (US).

### BACKGROUND OF THE INVENTION

Display parameters control the way a 2D or 3D image is visualized on a display. These display parameters may be modified with help of software or hardware user interface gadgets.

In 2D imaging and 3D imaging the way images are displayed on a screen may be changed by manipulating valuators. Valuators are a logic class of units used in graphical systems as inputs of scalars. Valuators are used to set different graphic parameters, such as rotation angle, scale factors and to set physical parameters associated with a specific application, such as temperature setting, volt level, etc.

Other approaches of changing the ways of displaying images on a screen is by dragging a mouse or joystick over specific regions on the display or interacting with wheels on a dialbox. A dialbox is a box that contains six or eight (hardware) dials. These dials are used to alter parameters assigned to them. Another way to modify the (software) parameters is to use any hardware device that is designed for that purpose. As a result of the manipulation the reconstruction of voxel gray values to display gray or color values is changed.

The Philips ViewForum workstation offers the possibility to change the visualization of voxels from an image dataset by means of the manipulation of a valuator or by dragging the mouse over a specific region on the display, i.e. so-called Direct Mouse Manipulation. This may result in changing the window width and level of a 2D image dataset or changing the visibility, i.e. opacity map, of a structure present in a 3D image dataset.

A problem of prior art is that the valuator gadgets almost never are large enough to display the required scale range, as the amount of screen area available for user interaction is limited. Limiting the scale range to fit the window screen area results in loss of resolution. To solve this problem a modifiable scale range and offset may be used. However, modification of the scale range and offset requires additional user interactions, which are time consuming.

In the ViewForum application valuators and display drag areas have a linear scale range. To enable high interaction accuracy or cover larger parameter ranges it is possible to modify the valuator scale range and offset. The acceleration of the mouse while dragging may also be used as a discriminator for interacting with high sensitivity or interacting with large steps. However this feature is currently not enabled as the behavior of such system is difficult to predict and thus it is easier to predict what happens when the mouse moves over a linear scale.

Another problem is that a minimum sensitivity is required when manipulating image display parameters by dragging the mouse over certain display areas. Multiple drags are unavoidable when large parameter changes are requested. When direct mouse manipulation is used to change a parameter it is necessary to both be able to cover the required (possibly large) range and to accurately define the final (possibly small) value. This requirement however cannot be fulfilled with the current linear scale definitions. Either the scale has a high sensitivity and covers a small range or the scale has a low sensitivity and covers a large range.

Accordingly, either a large amount of display space is required to accurately modify the image display parameters, or many user interactions are needed to overcome the high sensitivity of the user interface gadgets that accurately perform the given task within a limited amount of display space.

Hence, an improved method for modifying image display properties allowing for increased flexibility, cost-effectiveness, time-effectiveness, and user friendliness would be advantageous.

### SUMMARY OF THE INVENTION

Accordingly, the present invention preferably seeks to mitigate, alleviate or eliminate one or more of the above-identified deficiencies in the art and disadvantages singly or in any combination and solves at least the above-mentioned problems by providing a method, apparatus and a computer-readable medium according to the appended patent claims.

According to one aspect of the invention, a method for use in scale-based visualization of an image dataset is provided. The method comprises identifying a first set of voxels of the image dataset, wherein the voxels of the first set of voxels comprises gray values that are statistically frequently present in the image dataset, identifying a second set of voxels, wherein the voxels of the second set of voxels comprises gray values that are not statistically frequently present in the image dataset, and calculating a scale based on the first set of voxels and the second set of voxels using a transfer function, wherein the transfer function is non-linear.

In another aspect of the invention an apparatus for use in scale-based visualization is provided. The apparatus comprises a first identification unit for identifying a first set of voxels of the image dataset, wherein the voxels of the first set of voxels comprises gray values that are statistically frequently present in the image dataset, a second identification unit for identifying a second set of voxels, wherein the voxels of the second set of voxels comprises gray values that are not statistically frequently present in the image dataset, and

a calculation unit for calculating a scale based on the first set of voxels and the second set of voxels using a transfer function, wherein the transfer function is non-linear.

In yet another aspect a computer-readable medium having embodied thereon a computer program for processing by a computer is provided. The computer program comprises a first identification code segment for identifying a first set of voxels of the image dataset, wherein the voxels of the first set of voxels comprises gray values that are statistically frequently present in the image dataset, a second identification code segment for identifying a second set of voxels, wherein the voxels of the second set of voxels comprises gray values that are not statistically frequently present in the image dataset, and a calculation code segment for calculating a scale based on the first set of voxels and the second set of voxels using a transfer function, wherein the transfer function is non-linear.

The purpose of this invention is to eliminate the shortcomings of prior art and to offer high manipulation accuracy where required within a limited amount of display space. This may be achieved by changing the linear interaction scale into a non-linear scale, by giving important image dataset gray values a higher percentage of interaction space on the available display space than other less important image dataset gray values. This means that important image dataset gray values, e.g. gray values located in the vicinity of the mouse drag start position are taken into account with the highest possible interaction resolution. Gray values with very low importance will be skipped automatically because of the limited accuracy of the user interface. Accordingly the method according to some embodiments saves valuable display area and increases interaction performance.

### BRIEF DESCRIPTION OF THE DRAWINGS

These and other aspects, features and advantages of which the invention is capable of will be apparent and elucidated from the following description of embodiments of the present invention, reference being made to the accompanying drawings, in which

FIG. 1 is a screen dump from the Philips ViewForum system;

FIG. 2 is a schematic view of a method according to an embodiment;

FIG. 3 is an illustration of a practical implementation of a method according to an embodiment;

FIG. 4 is a schematic view of an apparatus according to an embodiment; and

FIG. 5 is a schematic view of a computer readable medium according to an embodiment.

### DESCRIPTION OF EMBODIMENTS

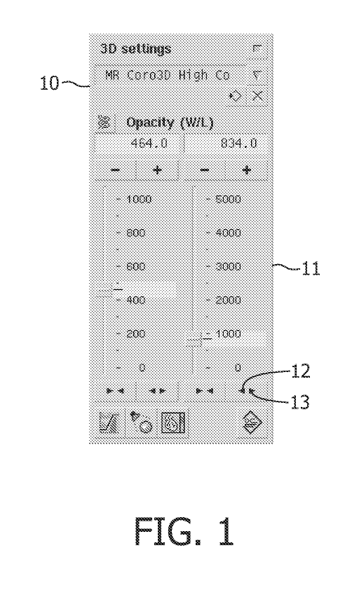

FIG. 1 illustrates a screen dump from the current Philips ViewForum system 10 comprising valuator gadgets 11 with scale range buttons 12, 13.

The following description focuses on embodiments of the present invention applicable to applications that modify image dataset (comprising pixels or voxels) display properties by dragging the mouse over certain areas on the display, such as a viewport, or by manipulating user interface gadgets, such as a valuator or specific hardware, such as a joystick or spaceball or any other physical input device.

The present invention provides elimination of the above-mentioned shortcomings of prior art and offers high manipulation accuracy where required within a limited amount of display space. In most cases it is not needed to offer access to all gray values through the valuator, display drag area or joystick. Instead of offering a linear scale, the scale may be non-linear.

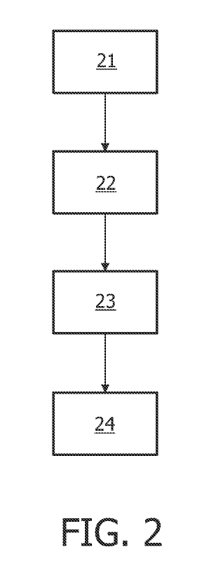

In an embodiment, according to FIG. 2, a method for visualization of an image dataset is provided. The method comprises the following steps:

identifying 21 a first set of voxels of the image dataset for high accuracy visualization,

identifying 22 a second set of voxels of the image dataset for low accuracy visualization, and

calculating 23 a scale based on the first set and second set of voxels. The method according to this embodiment provides a high accuracy for important, i.e. first set of voxels and a low accuracy for less important, i.e. second set of voxels values. This means that the first set of voxels are given a higher-percentage of interaction space on the available display space than the second set of voxels.

In an embodiment the identifying of the first set of voxels and the identifying of the second set of voxels are performed using histogram equalization. An intermediate result of the histogram equalization is a transfer function f(x) (see more details below) that has a steeper upslope, i.e. high first derivative, for voxel gray values that are present more often A digital implementation of histogram equalization is usually performed by defining a transfer function of the form:

f(x)=max(0, round[Dₘ*nₓ/N²)]−1) where N is the number of image pixels and nₓ is the number of pixels at intensity level x or less. Dₘ is the number of intensity levels present in the image.

To calculate the image pixel values from the non-linear output scale, the output scale values are mapped through the inverse version of that transfer function. Thus voxels with gray values that are present more often receive more physical display interaction space.

In another embodiment the identifying steps are performed using any other method that re-distributes gray values along the available display space.

In an embodiment the calculating step involves deriving the scale range and offset from an area around the center of the original image dataset because it is most likely that the structure of interest is present at the center of the image dataset voxel contents.

In another embodiment the calculating step involves determining the scale range and offset from the image dataset voxel contents around the initial display drag area starting point in case the structure of interest is not present at the center of the image dataset voxel contents.

In another embodiment the calculating step involves determining the scale range and offset from a volume of interest defined in the image dataset.

The result of using the method according to some embodiments is that voxels with gray values that need a high manipulation resolution get assigned more display space than the voxels with gray values that need less manipulation resolution.

In an embodiment the calculated scale is forwarded to a rendering algorithm 24 producing a 2D or 3D visualization of the image dataset for presentation on a display. For 2D visualizations and 3D maximum intensity projections the method according to embodiments facilitates when defining the gray-level window width and level parameters. For 3D shaded volume rendered visualizations the method is useful when manipulating the opacity map or color map. A maximum intensity projection is a 2D projection of a 3D image volume along a given viewing direction. For each point in the 2D projection, a ray is cast along the given viewing direction through the 3D volume, and then the point in the 2D projection is assigned the maximum value that was encountered along the ray. In this way, lower brightness values in the 3D volume can never occlude higher brightness values in the 2D projection. The viewing direction may be freely chosen by the user, e.g. by mouse interaction, or automatically rotated around a given axis, such as the vertical body axis.

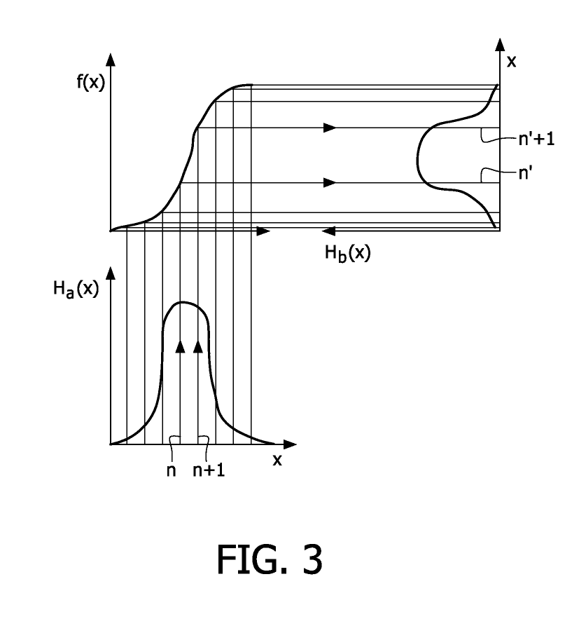

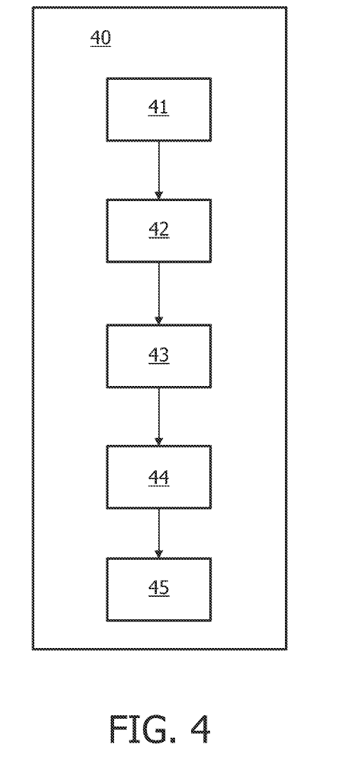

In an embodiment, according to FIG. 3, a practical implementation of the method is provided. Using histogram equalization the gray values of higher importance, i.e. the voxels with gray values that are present more often are stretched over a larger scale than the voxels with gray values that are present less often. A histogram displays at the x-axis the voxel values and at the y-axis the number of times the voxel values are present. So voxels that are present more often than others, have a higher peak in the histogram. Transfer function f(x) is calculated by accumulating the histogram y-axis values as explained above. Values at and around the steep slope of f(x) are given more display space and thus have a higher manipulation accuracy. The intermediate result of histogram equalization is a look-up table F(x) (see FIG. 3) see also the explanation of the well-known histogram equalization function that can be used to transform an original histogram Hₐ into a so-called equalized histogram H_{b}, e.g. the value n in function Hₐ is translated through look-up table F: n′=F(n) where n′ is the new scale value of function H_{b}. To determine the original value n from the scale value n′, scale value n′ can be found with help of the inverse function F(x). This may be observed from FIG. 3 where voxels of histogram Hₐ in range n, n+1 are mapped to voxels of histogram H_{b} in a transformed range n′, n′+1. Instead of using the scale of function Hₐ(x) for parameter manipulation wherein x defines the voxel location, the scale of function H_{b}(x) is used. High interaction accuracy is obtained for voxels in range n, n+1 and low interaction accuracy outside this range. In an embodiment the voxels are pixels in a 2D image dataset. In an embodiment, according to FIG. 4, an apparatus 40 for visualization of an image dataset is provided. The apparatus 40 comprises:

a first identification unit 41 for identifying a first set of voxels of the image dataset that are frequently present for high accuracy visualization,

a second identification unit 42 for identifying a second set of voxels of the image dataset that are not frequently present for low accuracy visualization, and

a calculation unit 43 for calculating a scale based on the first set of voxels and second set of voxels using a transfer function, wherein the transfer function is non-linear, and comprises a derivative, wherein the derivate for the first set of voxels is higher than the derivate for the second set of voxels.

In an embodiment of the invention the apparatus 40 further comprises a render unit 44 for rendering a 2D or 3D visualization of the image dataset based on the calculated scale. Typical interactions on a 2D image are gray-value adaptations (window level/width). 3D image setting interactions are less common. However, typical (expert) interactions on 3D images are manipulations of the opacity map and color map.

In an embodiment the apparatus 40 further comprises a display unit 45 for displaying the rendered 2D or 3D visualization to a user. For 2D visualizations and 3D maximum intensity projections the introduced methods helps when defining the gray-level window width and level parameters. For 3D shaded volume rendered visualizations the method is useful when manipulating the opacity map or color map.

The first identification unit 41, second identification unit 42, calculation unit 43, and render unit 44 may be any unit normally used for performing the involved tasks, e.g. a hardware, such as a processor with a memory. The processor may be any of variety of processors, such as Intel or AMD processors, CPUs, microprocessors, Programmable Intelligent Computer (PIC) microcontrollers, Digital Signal Processors (DSP), etc. However, the scope of the invention is not limited to these specific processors. The memory may be any memory capable of storing information, such as Random Access Memories (RAM) such as, Double Density RAM (DDR, DDR2), Single Density RAM (SDRAM), Static RAM (SRAM), Dynamic RAM (DRAM), Video RAM (VRAM), etc. The memory may also be a FLASH memory such as a USB, Compact Flash, SmartMedia, MMC memory, MemoryStick, SD Card, MiniSD, MicroSD, xD Card, TransFlash, and MicroDrive memory etc. However, the scope of the invention is not limited to these specific memories.

In an embodiment the apparatus comprises units for performing the method according to some embodiments.

In an embodiment the apparatus is comprised in a medical workstation or medical system, such as a Computed Tomography (CT) system, Magnetic Resonance Imaging (MRI) System or Ultrasound Imaging (US) system.

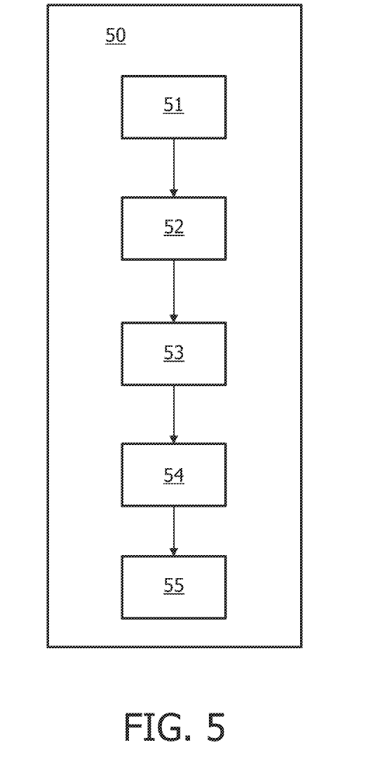

In an embodiment, according to FIG. 5, a computer-readable medium having embodied thereon a computer program 50 for processing by a computer is provided. The computer-readable medium comprises:

a first identification code segment 51 for identifying a first set of voxels of the image dataset that are frequently present for high accuracy visualization,

a second identification code segment 52 for identifying a second set of voxels of the image dataset that are not frequently present for low accuracy visualization, and

a calculation code segment 53 for calculating a scale based on the first set of voxels and second set of voxels using a transfer function, wherein the transfer function is non-linear, and comprises a derivative, wherein the derivate for the first set of voxels is higher than the derivate for the second set of voxels.

In an embodiment the computer program 50 further comprises a render code segment 54 for rendering a 2D or 3D visualization of the image dataset based on the calculated scale. Typical interactions on a 2D image are gray-value adaptations (window level/width). 3D image setting interactions are less common. However, typical (expert) interactions on 3D images are manipulations of the opacity map and color map.

In an embodiment the computer program 50 further comprises a display code segment 55 for displaying the rendered 2D or 3D visualization to a user. For 2D visualizations and 3D maximum intensity projections the introduced methods helps when defining the gray-level window width and level parameters. For 3D shaded volume rendered visualizations the method is useful when manipulating the opacity map or color map.

In an embodiment the computer-readable medium comprises code segments arranged, when run by an apparatus having computer-processing properties, for performing all of the method steps defined in some embodiments.

If the method according to an embodiment is used by an application it may be detected as follows, 1) loading an image into the application, and 2) examining the scale of the user interface gadget or determining it for the user interface display drag area or dialbox. In the latter cases the parameter value should be visible somewhere on the user interface. 3) Loading another image with a different content into the application and 4) examining the scale of the user interface gadget or determining it for the user interface display drag area or dialbox. The method according to an embodiment is used when the scale of the user interface gadget is non-linear and different for both cases.

Applications and use of the above-described embodiments according to the invention are various and include exemplary fields that utilize modification of image dataset display properties for visualization of an image dataset.

The invention may be implemented in any suitable form including hardware, software, firmware or any combination of these. However, preferably, the invention is implemented as computer software running on one or more data processors and/or digital signal processors. The elements and components of an embodiment of the invention may be physically, functionally and logically implemented in any suitable way. Indeed, the functionality may be implemented in a single unit, in a plurality of units or as part of other functional units. As such, the invention may be implemented in a single unit, or may be physically and functionally distributed between different units and processors.

Although the present invention has been described above with reference to specific embodiments, it is not intended to be limited to the specific form set forth herein. Rather, the invention is limited only by the accompanying claims and, other embodiments than the specific above are equally possible within the scope of these appended claims. Also combinations of the specific embodiments are equally possible within the scope of the invention.

In the claims, the term “comprises/comprising” does not exclude the presence of other elements or steps. Furthermore, although individually listed, a plurality of means, elements or method steps may be implemented by e.g. a single unit or processor. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second” etc do not preclude a plurality. Reference signs in the claims are provided merely as a clarifying example and shall not be construed as limiting the scope of the claims in any way.

1. A method for use in scale based visualization of an image dataset, said method comprising:
identifying a first set of voxels of the image dataset, wherein the voxels of said first set of voxels comprises gray values that are statistically frequently present in said image dataset,
identifying a second set of voxels, wherein the voxels of said second set of voxels comprises gray values that are not statistically frequently present in said image dataset, and
calculating a scale based on said first set of voxels and said second set of voxels using a transfer function, wherein said transfer function is non-linear.

2. The method according to claim 1, wherein said transfer function has a derivative for said first set of voxels and said second set of voxels, wherein said derivative for said first set of voxels is higher than said derivative for said second set of voxels.

3. The method according to claim 1, further comprising visualizing, based on said calculated scale, said first set of voxels in a first resolution and said second set of voxels in a second resolution on a display, wherein said first resolution is higher than said second resolution.

4. The method according to claim 1, comprising histogram equalization, wherein said histogram comprises said identifying said first set of voxels, said identifying said second set of voxels and said non-linear transfer function.

5. The method according to claim 4, wherein said histogram equalization comprises transforming an original histogram Ha into an equalized histogram Hb based on a look-up table derived from said histogram equalization.

6. The method according to claim 1, further comprising calculating original voxel values of said scale by an inverse version of said transfer function.

7. The method according to claim 1, further comprising re-distributing gray values along available display space for identifying said first set of voxels and identifying said second set of voxels.

8. The method according to claim 1, wherein said calculating said scale comprises deriving the scale from said first set of voxels and said second set of voxels present in said image dataset.

9. The method according to claim 1, wherein said calculating said scale comprises deriving the scale from voxels present inside a defined structure or present in an area around a center of said image dataset.

10. The method according to claim 1, wherein said calculating said scale comprises determining the scale from image dataset voxel contents around an initial display drag area starting point.

11. The method according to claim 1, wherein said image dataset is a 2D, 3D, or multi-dimensional medical image dataset.

12. The method according to claim 1, further comprising rendering (24) said calculated scale producing a 2D or 3D visualization of said image dataset for presentation on a display.

13. An apparatus (40) for use in scale based visualization of an image dataset, said apparatus comprising:
a first identification unit (41) for identifying a first set of voxels of the image dataset, wherein the voxels of said first set of voxels comprises gray values that are statistically frequently present in said image dataset,
a second identification unit (42) for identifying a second set of voxels, wherein the voxels of said second set of voxels comprises gray values that are not statistically frequently present in said image dataset, and
a calculation unit (43) for calculating a scale based on said first set of voxels and said second set of voxels using a transfer function, wherein said transfer function is non-linear.

14. The apparatus (40) according to claim 13, further comprising a render unit (44) for rendering a 2D or 3D visualization of said image dataset based on said calculated scale.

15. The apparatus (40) according to claim 13, further comprising a display unit (45) for displaying the rendered 2D or 3D visualization to a user.

16. The apparatus according to claim 13 being comprised in a medical workstation or medical system, such as a Computed Tomography (CT) system, Magnetic Resonance Imaging (MRI) System or Ultrasound Imaging (US) system.

17. A computer-readable medium (50) having embodied thereon a computer program executable by a processor, said computer program comprising:
a first identification code segment (51) for identifying a first set of voxels of the image dataset, wherein the voxels of said first set of voxels comprises gray values that are statistically frequently present in said image dataset,
a second identification code segment (52) for identifying a second set of voxels, wherein the voxels of said second set of voxels comprises gray values that are not statistically frequently present in said image dataset, and
a calculation code segment (53) for calculating a scale based on said first set of voxels and said second set of voxels using a transfer function, wherein said transfer function is non-linear.

18. The computer-readable medium (50) according to claim 17, further comprising a render code segment (54) for rendering a 2D or 3D visualization of said image dataset based on said calculated scale.

19. The computer-readable medium (50) according to claim 18, further comprising a display code segment (55) for displaying said rendered 2D or 3D visualization on a display.

20. The computer-readable medium according to claim 17, comprising code segments executable by a processor for performing a method for use in scale based visualization of an image dataset, said method comprising:
identifying a first set of voxels of the image dataset, wherein the voxels of said first set of voxels comprises gray values that are statistically frequently present in said image dataset,
identifying a second set of voxels, wherein the voxels of said second set of voxels comprises gray values that are not statistically frequently present in said image dataset, and
calculating a scale based on said first set of voxels and said second set of voxels using a transfer function, wherein said transfer function is non-linear.
